(19) United States
(12) Patent Application Publication
(10) Pub. No.: US 2025/0207643 A1
(43) Pub. Date: Jun. 26, 2025

(54) CALIPER BRAKE

(71) Applicant: HL MANDO CORPORATION, Pyeongtaek-si, Gyeonggi-do (KR)

(72) Inventor: Dongkoo KANG, Seoul (KR)

(73) Assignee: HL MANDO CORPORATION, Pyeongtaek-si, Gyeonggi-do (KR)

(21) Appl. No.: 18/847,473

(22) PCT Filed: Mar. 14, 2023
(86) PCT No.: PCT/KR2023/003389

§ 371 Date: Sep. 16, 2024

(30) Foreign Application Priority Data
Mar. 18, 2022 (KR) 10-2022-0033894

(51) Int. Cl. F16D 55/226; F16D 55/00; F16D 65/18; F16D 121/04; F16D 125/06

(52) U.S. Cl. CPC F16D 55/226; F16D 65/183; F16D 2055/0016; F16D 2121/04; F16D 2125/06

(57) ABSTRACT

A caliper brake is disclosed. According to an aspect of the present disclosure, the caliper brake may include: a carrier installed so that a pair of pad plates are movable toward and away from a disk side; a caliper housing slidably provided on the carrier and including a cylinder, a first piston installed in the cylinder and provided to be movable toward and away from the pad plates by hydraulic brake pressure; a second piston installed in the first piston and provided to be movable toward and away from the pad plates by hydraulic brake pressure; and a power-conversion unit installed through the cylinder and pressurizing the second piston by receiving driving power from an actuator.

### TECHNICAL FIELD

The present disclosure relates to a caliper brake, and more particularly, to a caliper brake capable of keeping a position of a piston constant before and after braking.

### BACKGROUND ART

In general, a caliper brake may be provided with a disc that rotates with a wheel of a vehicle, a carrier on which a pair of pad plates are installed to be movable forward and backward so as to pressurize the disc, and a caliper housing having a cylinder that is slidably installed in the carrier and has a piston installed to be movable backward and forward by hydraulic brake pressure.

Such a caliper brake performs a braking action by pressurizing the piston according to the hydraulic brake pressure, and additionally performs a parking brake action by pressurizing the piston by a spindle unit that employs an electrically operating actuator to receive rotational force of a motor and convert a rotational movement into a linear movement. In this case, the caliper brake typically uses a method of moving a piston backward by using a seal member that is accommodated in a seal groove recessed in a cylinder and a roll-back chamber inside the seal groove in order to reduce a drag phenomenon in which a friction pad attached to a disc and a pair of pad plates continue to rub after braking action.

The seal member serves to seal between an inner surface of the cylinder and an outer surface of the piston to prevent a braking fluid from leaking, and also return the piston to its original position. After the braking operation is completed, the seal member serves to move the piston, that has moved forward, backward again and restore the piston to its original position by the elasticity of the seal member being deformed and then restored. This is called roll-back.

However, in the conventional caliper brake, when the brake is released, the elastic deformation of the seal member is maintained, causing slip in which the piston continues to move backward. Accordingly, the conventional caliper brake had a problem in which the piston did not return to its original position when the brake was released after braking. As a result, there was a problem that the braking force was reduced and the drag phenomenon occurred. Accordingly, a method of minimizing engine damage and driving force loss and preventing a decrease in fuel and power efficiency during driving by preventing these problems is being studied.

### DISCLOSURE

### Technical Problem

An exemplary embodiment of the present disclosure is to provide a caliper brake capable of keeping a position of a piston constant before and after braking by including separate first and second pistons.

An exemplary embodiment of the present disclosure is to provide a caliper brake capable of keeping a position of a piston constant before and after braking by generating additional hydraulic brake pressure in a cylinder for a preset time during parking brake.

An exemplary embodiment of the present disclosure is to provide a caliper brake capable of preventing a decrease in braking force and a drag phenomenon by keeping a position of a piston constant before and after braking.

An exemplary embodiment of the present disclosure is to provide a caliper brake capable of preventing a decrease in braking force and a drag phenomenon from occurring to minimize engine damage and driving force loss and prevent a decrease in fuel and power efficiency during driving.

### Technical Solution

According to an aspect of the present disclosure, a caliper brake includes: a carrier on which a pair of pad plates are installed to be movable toward or away from a disc; a caliper housing that is slidably installed in the carrier and is provided with a cylinder; a first piston that is installed in the cylinder and provided to be movable toward or away from the pad plates by hydraulic brake pressure; a second piston that is installed in the first piston and provided to be movable toward or away from the pad plates by the hydraulic brake pressure; and a power conversion unit that is installed to penetrate through the cylinder and receives driving force from an actuator to move the second piston forward and backward.

The first piston may further include a second seal groove that is recessed in an inner surface, and a second seal member that is accommodated in the second seal groove and interposed between the first piston and the second piston.

The second seal member may include a first bent part that is accommodated in the second seal groove, and a second bent part that is bent and extends toward the second piston from the first bent part and at least partially contacts the second piston.

The cylinder may further include a first seal groove that is recessed in an inner surface, and a first seal member that is accommodated in the first seal groove and interposed between the first piston and the cylinder.

The first piston may include a guide groove that is formed to penetrate axially and accommodates at least a portion of the second piston.

The second piston may be slidably disposed in the guide groove.

The second piston may be provided to be movable forward and backward integrally with or independently from the first piston.

When the first piston and the second piston move forward and backward by the hydraulic brake pressure, the first bent part and the second bent part may move forward and backward integrally, and when the power conversion unit moves the second piston forward and backward, at least a portion of the second bent part may be in close contact with the second piston and elastically deformed.

The power conversion unit may include a spindle member that is installed to penetrate through a rear portion of the cylinder and rotates by receiving rotational force of an actuator, and a nut member that moves forward and backward according to a rotation of the spindle member and pressurizes and depressurizes the second piston.

The first piston and the second piston may further include a first contact part and a second contact part that are in contact with the pad plate, and in a driving state or when the parking brake is released, the first contact part and the second contact part may be disposed on the same reference line.

The nut member may be interposed between the spindle member and the second piston.

According to another aspect of the present disclosure, a caliper brake includes: a carrier on which a pair of pad plates are installed to be movable toward or away from a disc; a caliper housing that is slidably installed in the carrier and is provided with a cylinder; a piston that is installed in the cylinder and provided to be movable toward or away from the pad plates by hydraulic brake pressure; a power conversion unit that is installed to penetrate through the cylinder and receives driving force from an actuator to move the piston forward and backward; and a hydraulic supply unit that is provided with the cylinder and a passage so that a fluid inside the cylinder flows in and out, generates hydraulic brake pressure inside a hydraulic chamber of the cylinder during the parking brake, and releases the hydraulic brake pressure inside the hydraulic chamber when the parking brake is released, in which the hydraulic supply unit blocks a transmission of hydraulic pressure through the passage so that additional hydraulic brake pressure is generated inside the hydraulic chamber for a preset time when the parking brake is released.

The hydraulic supply unit may block the transmission of the hydraulic pressure through the passage so that the additional hydraulic brake pressure is generated for the preset time when a pressurized state of the piston by the power conversion unit is released during the releasing of the parking brake.

The caliper housing may include an oil port that is connected to the hydraulic supply unit and has a fluid flow in and out therethrough.

The cylinder may include a seal groove that is recessed in an inner surface, and a seal member that is accommodated in the seal groove and interposed between the cylinder and the piston.

When the parking brake is released, the transmission of the hydraulic pressure through the passage may be blocked so that the pressure applied to the seal member increases for the preset time.

The piston may include a first piston that is installed in the cylinder and provided to be movable toward or away from the pad plate by hydraulic brake pressure, and a second piston that is installed in the first piston and provided to be movable toward or away from the pad plate by the hydraulic brake pressure.

The cylinder and the first piston may include a first seal groove and a second seal groove that are recessed in the inner surface, further include a first seal member that is accommodated in the first seal groove and interposed between the first piston and the cylinder, and a second seal member that is accommodated in the second seal groove and interposed between the first piston and the cylinder.

The first piston may further include a guide groove that is formed to penetrate axially and accommodates at least a portion of the second piston, and the second piston may be slidably disposed in the guide groove.

The caliper brake may further include an electronic control unit that controls operations of the actuator and the hydraulic supply unit, in which the electronic control unit may transmit a signal to the hydraulic supply unit after the preset time has elapsed when the parking brake is released to allow the transmission of the hydraulic pressure through the passage.

### Advantageous Effects

According to an exemplary embodiment of the present disclosure, a caliper brake can keep a position of a piston constant before and after braking by including a separate first piston and a second piston.

According to an exemplary embodiment of the present disclosure, a caliper brake can generate additional hydraulic brake pressure in a cylinder for a preset time during parking brake to keep a position of a piston constant before and after braking.

According to an exemplary embodiment of the present disclosure, a caliper brake can keep a position of a piston constant before and after the braking to prevent a decrease in braking force and a drag phenomenon.

According to an exemplary embodiment of the present disclosure, a caliper brake can prevent a decrease in braking force and a drag phenomenon to minimize engine damage and driving force loss and prevent a decrease in fuel and power efficiency during driving.

### DESCRIPTION OF DRAWINGS

FIG. 1 is a cross-sectional view schematically illustrating a caliper brake according to an exemplary embodiment of the present disclosure.

FIG. 2 is an enlarged cross-sectional view illustrating a first piston and a second piston of the caliper brake according to an exemplary embodiment of the present disclosure.

FIG. 3 is an enlarged cross-sectional view illustrating a first seal member and a second seal member of the caliper brake according to an exemplary embodiment of the present disclosure.

FIG. 4 is a cross-sectional view illustrating an operating state of the caliper brake during hydraulic braking according to an exemplary embodiment of the present disclosure.

FIG. 5 is a cross-sectional view illustrating an operating state of a caliper brake during hydraulic braking release according to an exemplary embodiment of the present disclosure.

FIG. 6 is a cross-sectional view illustrating the operating state of the caliper brake during braking using an actuator of the caliper brake according to an exemplary embodiment of the present disclosure.

FIG. 7 is a cross-sectional view illustrating the operating state of the caliper brake during braking release using the actuator of the caliper brake according to an exemplary embodiment of the present disclosure.

FIG. 8 is a cross-sectional view schematically illustrating a caliper brake according to another exemplary embodiment of the present disclosure.

FIG. 9 is an enlarged cross-sectional view of a portion of the caliper brake according to another exemplary embodiment of the present disclosure.

FIG. 10 is an enlarged cross-sectional view of a seal groove and a seal member during parking brake of the caliper brake according to another exemplary embodiment of the present disclosure.

FIG. 11 is an enlarged cross-sectional view of the seal groove and the seal member in a state in which additional hydraulic brake pressure is not generated in the cylinder for a preset time when the parking brake of the caliper brake is released.

FIG. 12 is an enlarged cross-sectional view of the seal groove and the seal member when the additional hydraulic brake pressure is generated in the cylinder for a preset time when the parking brake of the caliper brake is released according to another exemplary embodiment of the present disclosure.

### BEST MODE

Hereinafter, exemplary embodiments of the present disclosure will be described in detail with reference to the accompanying drawings. The following exemplary embodiments are presented to sufficiently convey the idea of the present disclosure to those skilled in the art. The present disclosure is not limited only to the exemplary embodiments to be presented below, but may be embodied in other forms. In order to clarify the present disclosure, parts unrelated to the description may be omitted, and a size of components may be slightly exaggerated to aid understanding.

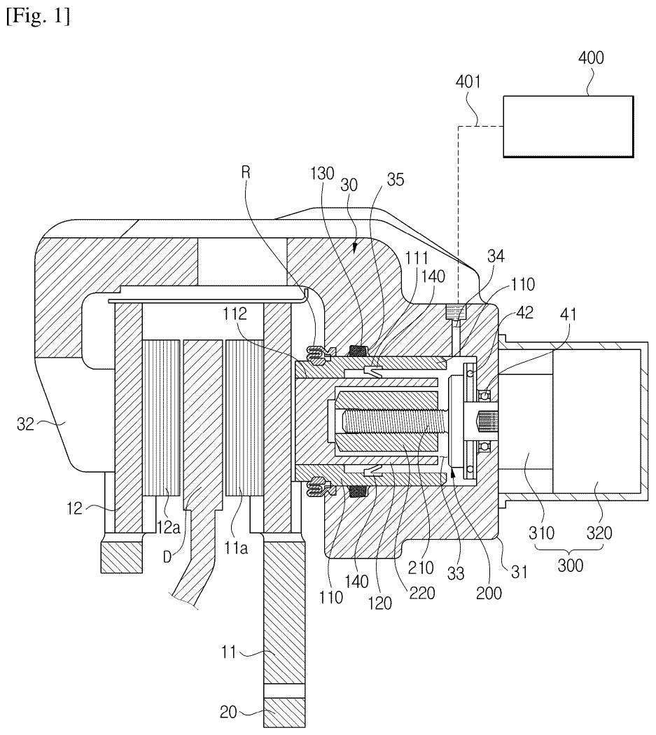

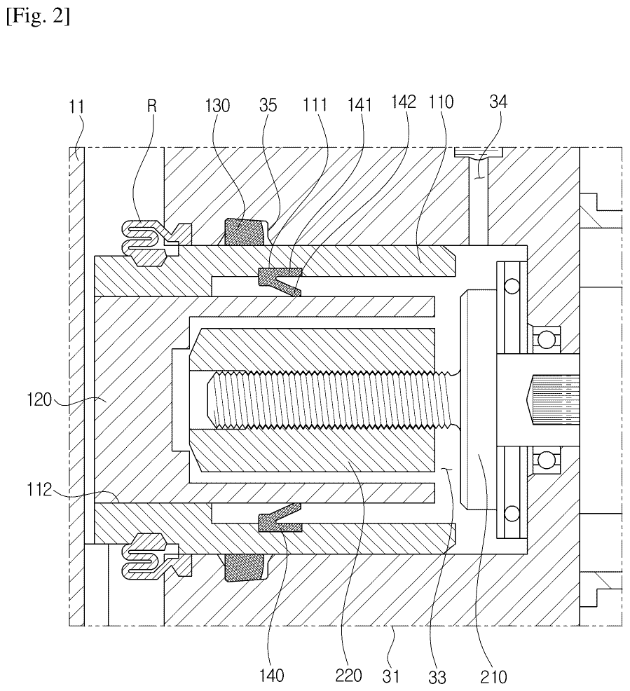

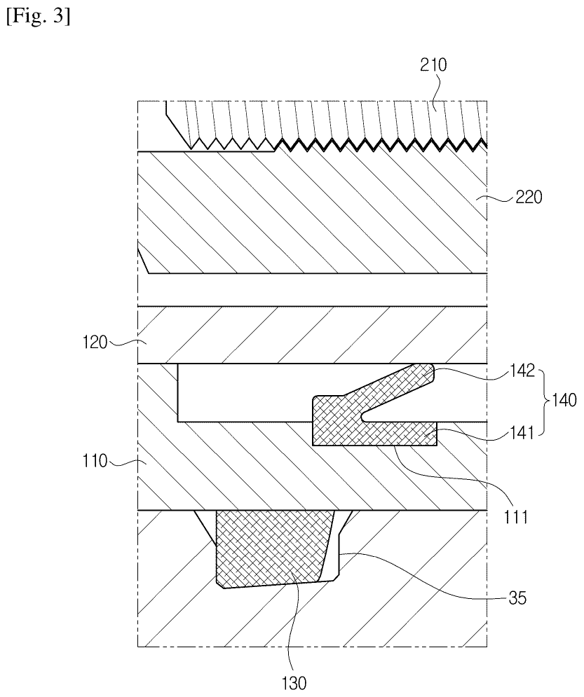

FIG. 1 is a cross-sectional view schematically illustrating a caliper brake according to an exemplary embodiment of the present disclosure, FIG. 2 is an enlarged cross-sectional view illustrating a first piston and a second piston of the caliper brake according to an exemplary embodiment of the present disclosure, and FIG. 3 is an enlarged cross-sectional view illustrating a first seal member and a second seal member of the caliper brake according to an exemplary embodiment of the present disclosure.

Referring to FIGS. 1 to 3, a caliper brake according to an exemplary embodiment of the present disclosure may include: a carrier 20 on which a pair of pad plates 11 and 12 are installed to be movable toward or away from a disc D, a caliper housing 30 that is slidably installed in the carrier 20 and is provided with a cylinder 31, a first piston 110 that is installed in the cylinder 31 and provided to be movable toward or away from the pad plates 11 and 12 by hydraulic brake pressure, a second piston 120 that is installed in the first piston 110 and provided to be movable toward or away from the pad plates 11 and 12 by the hydraulic brake pressure, and a power conversion unit 200 that is installed to penetrate through the cylinder 31 and receives driving force from an actuator 300 to convert rotational movement into linear movement so as to move the second piston 120 forward and backward.

The pair of pad plates 11 and 12 may include an inner pad plate 11 disposed to be in contact with the piston and an outer pad plate 12 disposed to be in contact with a finger part 32 of the caliper housing 30. The pair of pad plates 11 and 12 may be installed on the carrier 20 fixed to a vehicle body to be movable toward and away from both sides of the disc D. Friction pads 11a and 12a may be attached to one surface of each of the pad plates 11 and 12 facing the disc D.

The caliper housing 30 may be slidably installed in the carrier 20. The caliper housing 30 may be provided with a cylinder 31 and a hydraulic chamber 33, in which a braking fluid such as brake oil is supplied therein and a first piston 110 and a second piston 120 are accommodated so as to movable forward and backward. The caliper housing 30 may be provided with a finger part 32 formed to be bent forward to operate an outer pad plate 12. The cylinder 31 and the finger part 32 may be formed integrally, but are not limited thereto.

The caliper housing 30 may be provided with an oil port 34 through which the braking fluid such as the brake oil flows in so that the hydraulic brake pressure for braking may be applied to the hydraulic chamber 33 of the cylinder 31. The oil port 34 may be connected to a hydraulic supply unit 400.

The cylinder 31 may be installed in the caliper housing 30, and a spindle member 210 and a nut member 220 may be installed on a rear side of the cylinder 31. A boot R which is installed between an inlet of the cylinder 31 and the first piston 110 and prevents foreign substances from being introduced between the cylinder 31 and the first piston 110 may be included. A seal member may be provided between the first piston 110 and the cylinder 31 to prevent the braking fluid from leaking.

The cylinder 31 may have a first seal groove 35 formed in a recessed shape on its inner surface, and a first seal member 130 may be accommodated in the first seal groove 35. The first seal groove 35 may be formed in an annular recessed shape. The first seal member 130 may prevent leakage of the braking fluid between the first piston 110 and the cylinder 31, and may be elastically deformed when the first piston 110 moves forward (left direction based on FIG. 1) during parking brake or stop braking, and may also move the first piston 110 backward (right direction based on FIG. 2) by elastic restoring force when the parking or stopping is released.

The hydraulic supply unit 400 may supply the braking fluid such as the brake oil into the hydraulic chamber 33 of the cylinder 31 provided in the caliper housing 30, or recover the braking fluid inside the hydraulic chamber 33. The hydraulic supply unit 400 may be formed with the cylinder 31 and a passage 401 so that a fluid may flow in and out from the hydraulic chamber 33 of the cylinder 31. The passage 401 of the hydraulic supply unit 400 may be connected to the oil port 34 formed in the caliper housing 30.

The hydraulic supply unit 400 may supply the hydraulic brake pressure for braking implementation into the hydraulic chamber 33 of the cylinder 31, or recover the hydraulic brake pressure inside the hydraulic chamber 33. Specifically, the hydraulic supply unit 400 may supply the braking fluid into the hydraulic chamber 33 of the cylinder 31 to increase the pressure inside the hydraulic chamber 33. Inside the hydraulic chamber 33, the pistons 110 and 120 may be pressurized by the hydraulic brake pressure, and the pistons 110 and 120 may move forward to pressurize the inner pad plates 11 and 12. Alternatively, the hydraulic supply unit 400 may recover the braking fluid inside the hydraulic chamber 33 of the cylinder 31 to reduce the hydraulic pressure inside the hydraulic chamber 33. In this case, the hydraulic brake pressure inside the hydraulic chamber 33 may be released, the pistons 110 and 120 may move backward, and the inner pad plates 11 and 12 may be depressurized. The hydraulic supply unit 400 may be controlled by an electronic control unit (ECU) to increase or decrease the hydraulic brake pressure inside the hydraulic chamber 33 of the cylinder 31.

As an example of the hydraulic supply unit 400, it may be provided as a device capable of generating the hydraulic brake pressure by a hydraulic piston operating by an electric signal output in response to a displacement of a brake pedal. In addition, as another example, the hydraulic supply unit 400 may be provided as a master cylinder 31 that discharges a pressurized medium (braking fluid) according to an effort of the brake pedal. The hydraulic supply unit 400 is not limited thereto, and may be provided as various means capable of supplying the braking fluid into the hydraulic chamber 33 of the cylinder 31 provided in the caliper housing 30 or recovering the braking fluid inside the hydraulic chamber 33.

The power conversion unit 200 may include a spindle member 210, a nut member 220, and a power conversion unit. The spindle member 210 may be installed to penetrate through a rear portion of the cylinder 31 and rotate by receiving the rotational force of the actuator 300. The nut member 220 may move forward and backward according to the rotation of the spindle member 210 and pressurize and depressurize the second piston 120. The power transmission unit may transmit the rotational force of the actuator 300 to the spindle member 210.

The spindle member 210 may include a spindle body, a spindle flange formed to extend radially from the spindle body, and a spindle rod having a second screw part formed on an outer circumferential surface thereof. The spindle body may be disposed to penetrate through the cylinder 31 of the caliper housing 30, and the spindle flange and the spindle rod may be disposed inside the hydraulic chamber 33 of the cylinder 31.

In order to stably support the spindle member 210, an O-ring 41 and a bearing 42 may be provided in mutually spaced positions within the cylinder 31. The O-ring 41 may be provided between an outer circumferential surface of the spindle body and the cylinder 31 to rotatably support the spindle body, and the bearing 42 may be provided between the spindle flange and the cylinder 31 to rotatably support the spindle flange. The O-ring 41 may prevent a working fluid or the hydraulic brake pressure from leaking between the outer circumferential surface of the spindle body and the cylinder 31 by sealing a gap between the outer circumferential surface of the spindle body and the cylinder 31.

The nut member 220 may include a head part that is in contact with the second piston 120 and a rod part that extends from the head part and has a first screw part formed on an inner circumferential surface thereof to be screw-connected with the spindle member 210. The head part is provided to be in contact with the second piston 120 on the inner side of the second piston 120, and the rod part may form a space between an outer circumferential surface thereof and the inner circumferential surface of the piston to which the braking fluid may be supplied. The nut member 220 may be interposed between the spindle member 210 and the second piston 120.

The rod part of the nut member 220 has a through hole formed along a longitudinal direction on an inner side thereof to be screw-connected to a spindle rod of the spindle member 210, and a first screw part formed as a female thread (or male thread) may be provided on an inner circumferential surface of the through hole. In response to this, a second screw part formed as a male thread (or female thread) and engaging with the first screw part may be provided on an outer circumferential surface of the spindle rod. Accordingly, the nut member 220 may pressurize or depressurize the second piston 120 by moving forward according to rotation of the spindle member 210 in a first direction or moving backward according to rotation of the spindle member 210 in a second direction (opposite to the first direction).

The actuator 300 may include a motor 420 and a reducer 310. The reducer 310 may reduce power provided from the motor 420 and transmit the reduced power to a power transmission unit, and may be formed in various structures such as a planetary gear assembly. The motor 420 may be provided as a bidirectional motor 420, and the spindle member 210 may rotate in the first direction or the second direction according to a one-way rotation or the other-way rotation of the motor 420.

The first piston 110 may be installed in the cylinder 31 and may be provided to move toward and away from the pad plates 11 and 12 by the hydraulic brake pressure. The second piston 120 may be installed in the first piston 110 and may be provided to move toward and away from the pad plates 11 and 12 by the hydraulic brake pressure. The first piston 110 and the second piston 120 may be formed in a hollow shape with an empty interior and may be provided to be slidable on the hydraulic chamber 33 within the cylinder 31. The first piston 110 and the second piston 120 may be provided in a cup shape with an empty interior. The first piston 110 and the second piston 120 may move toward the inner pad plates 11 and 12 when the hydraulic brake pressure for braking is applied to the hydraulic chamber 33 to pressurize the inner pad plates 11 and 12, and by the reaction force, the caliper housing 30 may move in an opposite direction to the pistons 110 and 120, so the finger part 32 pressurizes the outer pad plates 11 and 12 toward the disc D to perform the braking.

The first piston 110 may be provided with a guide groove 112 that is formed to penetrate axially to accommodate at least a portion of the second piston 120. The second piston 120 may be slidably disposed in the guide groove 112 that is formed in the first piston 110. The second piston 120 may be provided to be slidable in the guide groove 112, and thus, when the second piston 120 moves forward and backward by the power conversion unit 200, may not deviate from a preset path to maintain uniform braking performance and driving performance. An inner diameter of the guide groove 112 may be provided to be equal to or larger than an outer diameter of the second piston 120.

The first piston 110 and the second piston 120 may include a first contact part and a second contact part that are in contact with the inner pad plate 11. The first contact part and the second contact part may be disposed on the same reference line A in a driving state or when the parking brake is released. By disposing the first contact part and the second contact part on the same reference line A in the driving state or when the parking brake is released to keep the position of the piston constant before and after the braking, it is possible to prevent the situation in which the first piston 110 and the second piston 120 do not simultaneously pressurize the pad plates 11 and 12, thereby preventing the decrease in braking force and the drag phenomenon.

The first piston 110 may include a second seal groove 111 recessed in the inner surface. A second seal member 140 is accommodated in the second seal groove 111, and the second seal member 140 may be interposed between the first piston 110 and the second piston 120. The second seal member 140 may move together with the first piston 110 and the second piston 120 when the first piston 110 and the second piston 120 move forward and backward according to the hydraulic brake pressure. That is, during the hydraulic braking or when the hydraulic braking is released, the second seal member 140 may allow the first piston 110 and the second piston 120 to move forward and backward integrally. The second seal member 140 may be elastically deformed when the first piston 110 and the second piston 120 move forward, and may also move the first piston 110 and the second piston 120 backward by the elastic restoring force when the parking or stopping is released. The second seal member 140 may have an axial cross-sectional shape in an L-shape.

The second seal member 140 may include a first bent part 141 that is accommodated in the second seal groove 111, and a second bent part 142 that is bent and extends from the first bent part 141 toward the second piston 120 and at least partially contacts the second piston 120. When the first piston 110 and the second piston 120 move forward and backward by the hydraulic brake pressure, the first bent part 141 and the second bent part 142 may integrally move forward and backward. When the second piston 120 is pressurized and depressurized by the power conversion unit 200, at least a portion of the second bent part 142 may be elastically deformed in close contact with the second piston 120. In detail, when the nut member 220 pressurizes and depressurizes the second piston 120, at least a portion of the second bent part 142 may be elastically deformed in close contact with the second piston 120.

The second seal member 140 is provided as an elastic body, but may be easily deformed according to the forward and backward movement of the second piston 120. The second piston 120 is slidably disposed in the guide groove 112 formed in the first piston 110, and may move forward and backward by the power conversion unit 200 through the actuator 300, and may operate independently of the first piston 110. In this case, when the second piston 120 returns to its original state, i.e., a reference position during the forward and backward movement of the second piston 120, the position and shape of the second seal member 140 also return to their original states.

The nut member 220 and the spindle member 210 of the power conversion unit 200 may be disposed inside the second piston 120. As the nut member 220 pressurizes or depressurizes the second piston 120, the second piston 120 can move toward and away from the pad plates 11 and 12. That is, the second piston 120 may move forward and backward through the spindle member 210 and the nut member 220 coupled to the spindle member 210, so the second piston 120 may pressurize the inner pad plate 11 toward the disc D to implement the braking.

The rotational force of the actuator 300 may be transmitted to the spindle member 210 through the power transmission unit, so the spindle member 210 may rotate in the first direction or the second direction. When the spindle member 210 rotates in the first direction, the nut member 220 may slide in a direction (left direction in FIG. 1) in which it moves forward on the hydraulic chamber and pressurizes the second piston 120, and when the spindle member 210 rotates in the second direction that is an opposite direction to the first direction, the nut member 220 may slide in a direction (right direction in FIG. 2) in which it moves backward on the hydraulic chamber 33 and depressurizes the piston.

The caliper brake according to an exemplary embodiment of the present disclosure may include the electronic control unit (ECU) that controls the operations of the power conversion unit 200 and the hydraulic supply unit 400. The electronic control unit according to an exemplary embodiment of the present disclosure may be implemented through a non-volatile memory configured to store data on an algorithm configured to control operations of various components of a vehicle or software instructions reproducing the algorithm and a processor configured to perform operations to be described below using the data stored in the non-volatile memory. Here, the memory and the processor may be implemented as individual chips. Alternatively, the memory and the processor may be integrated with each other and implemented as a single chip. The processor may have a form of one or more processors.

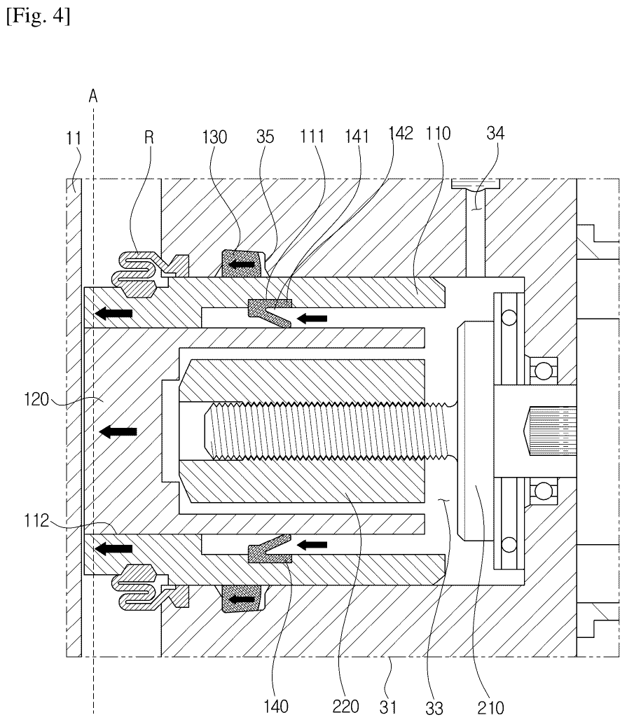

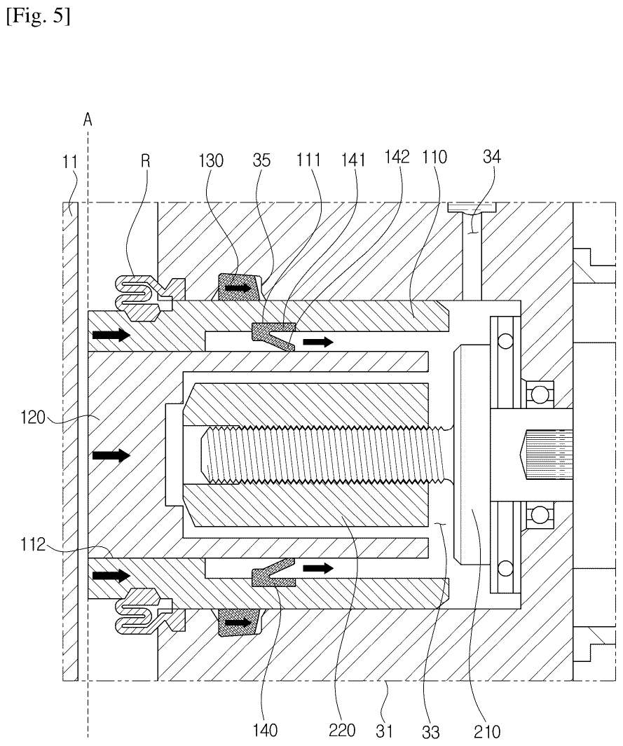

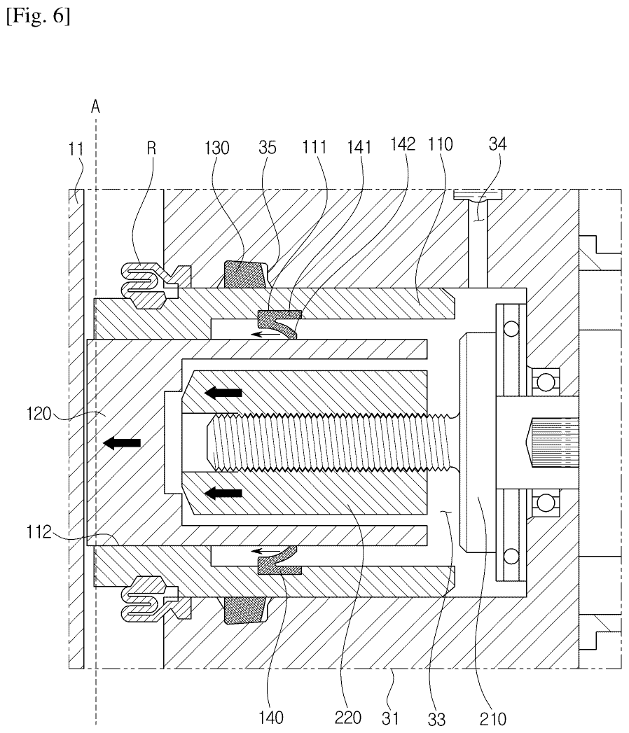

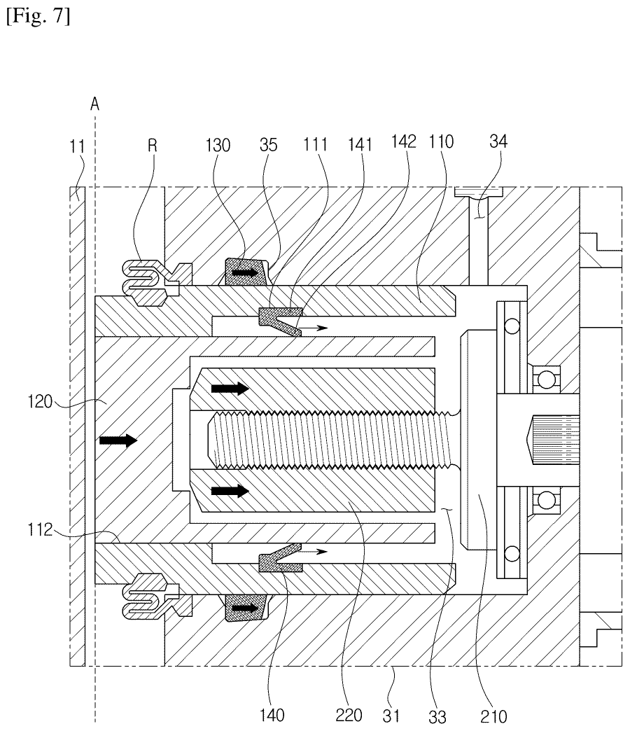

FIG. 4 is a cross-sectional view illustrating an operating state of the caliper brake during hydraulic braking according to an exemplary embodiment of the present disclosure, FIG. 5 is a cross-sectional view illustrating an operating state of a caliper brake during hydraulic braking release according to an exemplary embodiment of the present disclosure, FIG. 6 is a cross-sectional view illustrating the operating state of the caliper brake during braking using an actuator of the caliper brake according to an exemplary embodiment of the present disclosure, and FIG. 7 is a cross-sectional view illustrating the operating state of the caliper brake during braking release using the actuator of the caliper brake according to an exemplary embodiment of the present disclosure.

Referring to FIGS. 4 to 7, the electronic control unit may control the hydraulic supply unit 400 to generate the hydraulic brake pressure during the parking brake of the vehicle. Specifically, the braking fluid supplied by the hydraulic supply unit 400 may be introduced into the hydraulic chamber 33 of the cylinder 31 through the oil port 34. The hydraulic chamber 33 of the cylinder 31 may move forward in the direction in which the first piston 110 and the second piston 120 pressurize the inner pad plate 11 as the braking fluid is introduced and the internal pressure increases. As a result, the inner pad plate 11 may pressurize the disc D.

The electronic control unit may control the power conversion unit 200 to move the second piston 120 forward and backward through the actuator 300. According to the operation of the actuator 300, the spindle member 210 may rotate in the first direction (the direction in which the nut member 220 moves forward). Accordingly, the nut member 220 moves forward according to the rotation of the spindle member 210 in the first direction, so a front surface of the head part of the nut member 220 may support a front portion of the inner circumferential surface of the second piston 120.

Thereafter, the electronic control unit may control the hydraulic supply unit 400 to release the hydraulic brake pressure so that an internal pressure of the hydraulic chamber 33 of the cylinder 31 is reduced. In other words, the hydraulic supply unit 400 may recover the braking fluid supplied to the hydraulic chamber 33. The hydraulic chamber 33 of the cylinder 31 has its internal pressure reduced because the braking fluid is recovered to the hydraulic supply unit 400, but since the nut member 220 supports the second piston 120, the second piston 120 may be prevented from moving backward.

When the first piston 110 and the second piston 120 move forward in the direction in which the first piston 110 and the second piston 120 pressurizes the inner pad plate 11 by the hydraulic brake pressure, the first seal member 130 and the second seal member 140 may be elastically deformed. The first seal member 130 may pressurize wall surfaces of the pad plate 11 and 12 sides of the first seal groove 35, and the second seal member 140 may maintain a state in which at least a portion of the first bent part 141 and the second bent part 142 are in contact with the first piston 110 and the second piston 120.

When the power conversion unit 200 moves the second piston 120 forward in the direction in which it pressurizes the inner pad plate 11 through the actuator 300 without the forward and backward movement of the first piston 110, the second seal member 140 may be elastically deformed according to the forward movement of the second piston 120. At least a portion of the first bent part 141 and the second bent part 142 of the second seal member 140 may be maintained in contact with the first piston 110 and the second piston 120, and at least a portion of the second bent part 142 may be elastically deformed in close contact with the second piston 120 according to the forward movement of the second piston 120.

During the parking brake of the vehicle, the electronic control unit may cause the hydraulic supply unit 400 to generate the hydraulic brake pressure so that the first piston 110 and the second piston 120 move forward together. In this case, the actuator 300 may operate so that the second piston 120 further pressurizes the pad plates 11 and 12, thereby rotating the spindle member 210 in the first direction, and the nut member 220 may move forward according to the rotation of the spindle member 210 in the first direction so that the second piston 120 further pressurizes the pad plates 11 and 12. Alternatively, only the actuator 300 may operate separately from the hydraulic supply unit 400 to move the nut member 220 forward according to the rotation of the spindle member 210 in the first direction and pressurize the second piston 120, so only the second piston 120 may pressurize the pad plates 11 and 12.

Thereafter, the electronic control unit may control the hydraulic supply unit 400 to release the hydraulic brake pressure so that the internal pressure of the hydraulic chamber 33 of the cylinder 31 is reduced. To this end, the hydraulic supply unit 400 may recover the braking fluid supplied to the hydraulic chamber 33. The hydraulic chamber 33 of the cylinder 31 has its internal pressure reduced as the braking fluid is recovered to the hydraulic supply unit 400, but when the nut member 220 pressurizes the second piston 120 and the support state of the second piston 120 is maintained, the second piston 120 is prevented from moving backward, thereby maintaining the parking brake state of the vehicle.

Referring to FIGS. 4 and 7, when the parking brake of the vehicle is released, the electronic control unit may control the hydraulic supply unit 400 to release the hydraulic brake pressure so that the internal pressure of the hydraulic chamber 33 of the cylinder 31 is reduced. The hydraulic supply unit 400 may recover the braking fluid supplied to the hydraulic chamber 33 through the oil port 34 and passage 401. When the hydraulic brake pressure inside the cylinder 31 is released through the hydraulic supply unit 400, the internal pressure of the hydraulic chamber 33 is reduced, so the first piston 110 and the second piston 120 may move backward and move in the direction in which the pressurized state of the inner pad plate 11 is released. Through this, the pressurized state of the disk D of the inner pad plate 11 may be released.

The electronic control unit may rotate the spindle member 210 in the second direction that is the opposite direction to the first direction through the actuator 300. According to the rotation of the spindle member 210 in the second direction, the nut member 220 may be controlled to move backward and separate from the second piston 120, thereby releasing the pressurized state of the second piston 120.

When the hydraulic brake pressure is released, the first piston 110 and the second piston 120 may move backward, thereby releasing the pressurized state of the inner pad plate 11. As the first piston 110 and the second piston 120 move backward, the first seal member 130 and the second seal member 140 may be elastically deformed. The pressurized state of the wall surfaces on the pad plate 11 and 12 sides of the first seal groove 35 of the first seal member 130 may be released, and at least a portion of the first bent part 141 and the second bent part 142 of the second seal member 140 may be maintained in contact with the first piston 110 and the second piston 120. In this case, the first piston 110 and the second piston 120 may return to an initial position by the elastic restoring force of the first seal member 130 and the second seal member 140 along with the release of the hydraulic brake pressure.

When the power conversion unit 200 moves the second piston 120 backward in the direction in which it releases the pressurized state of the inner pad plates 11 and 12 through the actuator 300 without the forward and backward movement of the first piston 110, the second seal member 140 may be elastically deformed according to the backward movement of the second piston 120. At least a portion of the first bent part 141 and the second bent part 142 of the second seal member 140 may be maintained in contact with the first piston 110 and the second piston 120, and at least a portion of the second bent part 142 may be elastically deformed in close contact with the second piston 120 according to the backward movement of the second piston 120. In this case, the second piston 120 may return to the initial position by the elastic restoring force of the second seal member 140.

In order to reduce the drag phenomenon, a method of moving a piston backward by using a seal member accommodated in a seal groove recessed in a cylinder and a rollback chamber inside the seal groove is used, and when the rollback function is mounted to perform the function of moving the piston, which has moved forward, backward again and restoring the piston to its original position by the elasticity of the seal member that is deformed and then restored after the braking operation ends, a problem may occur in which the position of the piston is constant before and after the forward and backward movement of the piston when the piston moves forward and backward only by the hydraulic pressure, but the position of the piston is not constant before and after the forward and backward movement of the piston when the piston moves forward and backward using the actuator. Specifically, this is designed so that the seal member has a certain elastic deformation force so that the piston returns to its original position after the hydraulic braking is released based on when the hydraulic braking is released. When moving the piston forward and backward using the actuator, a phenomenon may occur in which the piston does not return to its original position when the piston moves backward using the actuator by the predetermined elastic deformation force of the seal member designed for the hydraulic braking.

The first piston 110 and the second piston 120 are provided separately, but the second piston 120 may can move forward and backward together with the first piston 110 during the hydraulic braking or when the hydraulic braking is released, and is provided to move forward and backward independently from the first piston 110 during the braking by the actuator 300 or when the braking is released by the actuator 300, thereby preventing the problem in which errors occur due to the inconsistent the positions of the first piston 110 and the second piston 120 before and after the forward and backward movement of the first piston 110 and the second piston 120, unlike the initial design.

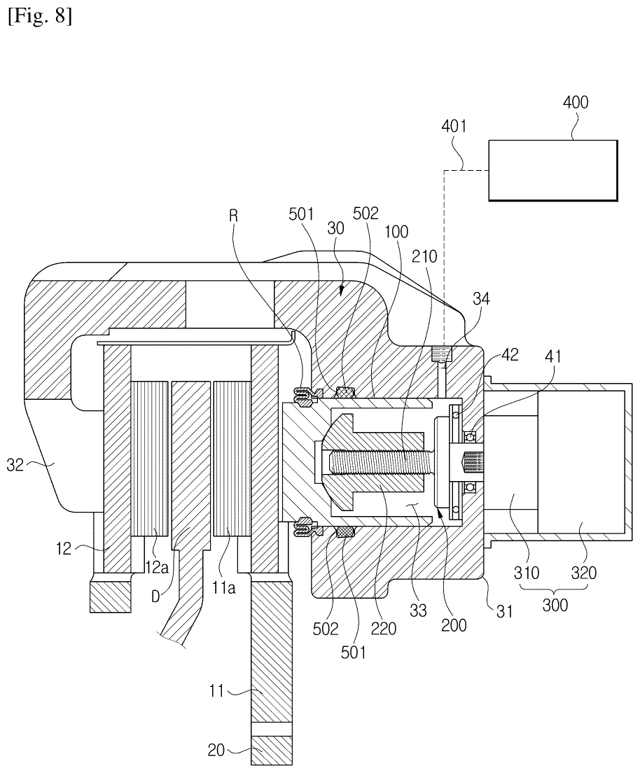

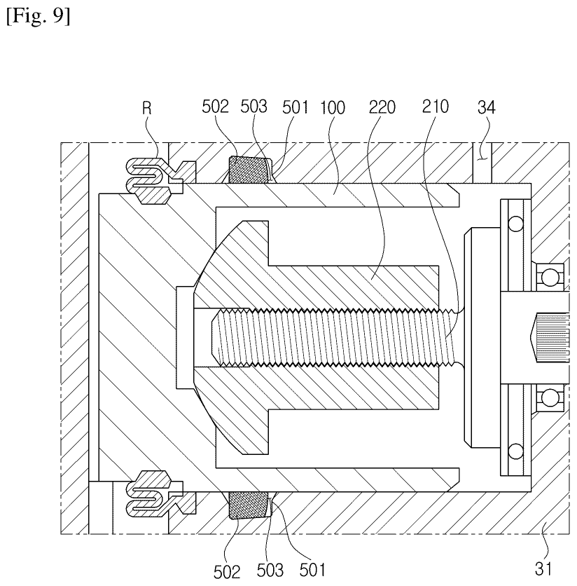

FIG. 8 is a cross-sectional view schematically illustrating a caliper brake according to another exemplary embodiment of the present disclosure, and FIG. 9 is an enlarged cross-sectional view of a portion of the caliper brake according to another embodiment of the present disclosure.

Referring to FIGS. 8 and 9, a caliper brake according to another exemplary embodiment of the present disclosure may include a carrier 20 on which a pair of pad plates 11 and 12 are installed to be movable toward or away from a disc D, a caliper housing 30 that is slidably installed in the carrier 20 and is provided with a cylinder 31, a piston 100 that is installed in the cylinder 31 and provided to be movable toward or away from the pad plates 11 and 12 by hydraulic brake pressure, a power conversion unit 200 that is installed to penetrate through the cylinder 31 and receives driving force from an actuator 300 to move the piston 100 forward and backward, and a hydraulic supply unit 400 that is provided with the cylinder 31 and a passage 401 so that a fluid inside the cylinder 31 flows in and out, generates hydraulic brake pressure inside a hydraulic chamber 33 of the cylinder 31 during the parking brake, and releases the hydraulic brake pressure inside the hydraulic chamber when the parking brake is released.

According to another exemplary embodiment of the present disclosure, the caliper brake may include an electronic control unit that controls the operations of the power conversion unit 200 and the hydraulic supply unit 400. When the parking brake is released, the electronic control unit may transmit a signal to the hydraulic supply unit 400 to block the transmission of the hydraulic pressure through the passage 401 so that additional hydraulic brake pressure is generated in the hydraulic chamber 33 for a preset time, and when the parking brake is released, may transmit a signal to the hydraulic supply unit 400 after the preset time has elapsed to allow the transmission of the hydraulic pressure through the passage 401.

The cylinder 31 may be provided with a seal groove 501 recessed in an inner surface, and a seal member 502 may be accommodated in the seal groove 501. The seal groove 501 may be formed in an annular recessed shape. The seal member 502 is elastically deformed when the piston 100 moves forward during the parking brake or the stop braking, and may also move the piston 100 backward by the elastic restoring force when the parking is released or the stopping is released. The power conversion unit 200 may include a spindle member 210, a nut member 220, and a power conversion unit, and the nut member 220 may move forward and backward according to the rotation of the spindle member 210 and pressurize and depressurize the piston 100. Matters not to be described later among each component of another exemplary embodiment of the present disclosure are the same as the shapes, arrangements, and operating structures according to the exemplary embodiment of the present disclosure described above.

The hydraulic supply unit 400 may be provided with the cylinder 31 and the passage 401 so that the fluid in the cylinder 31 flows in and out, and may generate the hydraulic brake pressure in the hydraulic chamber 33 of the cylinder 31 during the parking brake and release the hydraulic brake pressure in the hydraulic chamber 33 when the parking brake is released. The hydraulic supply unit 400 may be connected to the oil port 34 formed in the caliper housing 30.

The hydraulic supply unit 400 may generate additional hydraulic brake pressure in the hydraulic chamber 33 of the cylinder 31 for the preset time when the parking brake is released. In detail, the hydraulic supply unit 400 may block the transmission of the hydraulic pressure through the passage 401 so that the additional hydraulic brake pressure is generated inside the hydraulic chamber 33 for the preset time when the parking brake is released. The hydraulic pressure may be prevented from being transmitted from the hydraulic chamber 33 in the cylinder 31 to the hydraulic supply unit 400 through the oil port 34 and the passage 401 for the preset time, and the piston 100 in the cylinder 31 may move backward to reduce the volume of the hydraulic chamber 33, thereby increasing the hydraulic brake pressure in the hydraulic chamber 33. After the preset time has elapsed, the hydraulic pressure can be transmitted from the hydraulic chamber 33 to the hydraulic supply unit 400 through the oil port 34 and passage 401, thereby reducing the hydraulic brake pressure in the hydraulic chamber 33 of the cylinder 31.

The preset time is a value that may vary according to empirical rules, etc., and may also vary according to the specifications, conditions, etc., of the vehicle on which the caliper brake of one exemplary embodiment of the present disclosure or another exemplary embodiment is mounted. For example, the time during which the backward movement of the piston 100 through the actuator 300 is completed may be set as the preset time.

In addition, the amount of braking fluid in the hydraulic chamber 33 in the cylinder 31 is the same for the preset time, and the volume of the hydraulic chamber 33 decreases to increase the hydraulic brake pressure in the hydraulic chamber 33, so a gap may be formed between the piston 100 and the nut member 220, thereby preventing the state in which the nut member 220 does not smoothly move backward due to the engagement force acting between the piston 100 and the nut member 220.

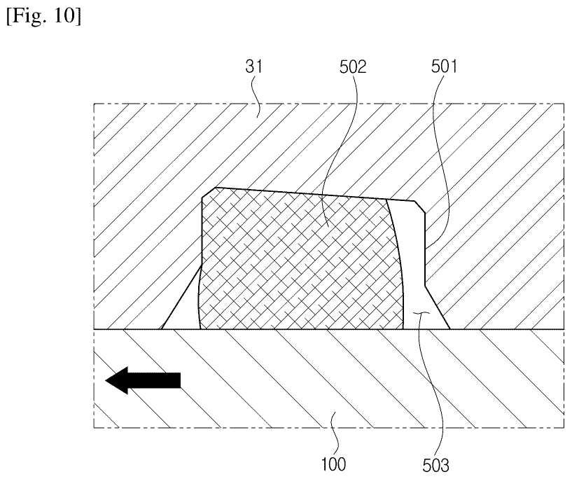

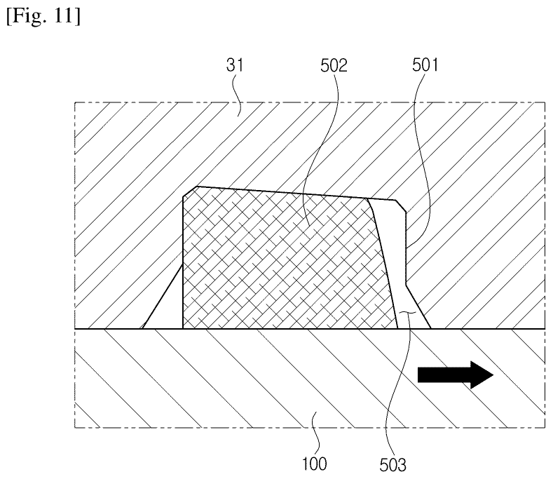

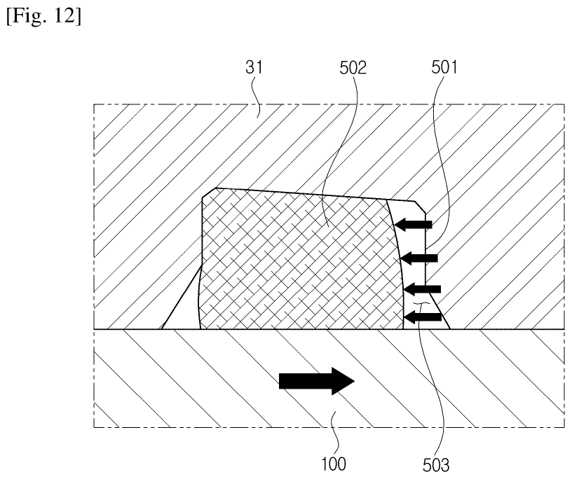

FIG. 10 is an enlarged cross-sectional view of a seal groove and a seal member during parking brake of the caliper brake according to another exemplary embodiment of the present disclosure, FIG. 11 is an enlarged cross-sectional view of the seal groove and the seal member in a state in which additional hydraulic brake pressure is not generated for a preset time when the parking brake of the caliper brake is released, and FIG. 12 is an enlarged cross-sectional view of the seal groove and the seal member when the additional hydraulic brake pressure is generated in the cylinder for a preset time when the parking brake of the caliper brake is released according to another exemplary embodiment of the present disclosure.

Referring to FIGS. 10 to 12, there is a difference in the degree of elastic deformation of the seal member 502 in the seal groove 501 during the parking brake of the caliper brake or when the brake is released, and a volume of a seal member accommodation space 503 in the seal groove 501 may vary.

In order to reduce the drag phenomenon, a method of moving a piston backward by using a seal member accommodated in a seal groove recessed in a cylinder and a rollback chamber inside the seal groove is used, and when the rollback function is mounted to perform the function of moving the piston, which has moved forward, backward again and restoring the piston to its original position by the elasticity of the seal member that is deformed and then restored after the braking operation ends, a problem may occur in which the position of the piston is constant before and after the forward and backward movement of the piston when the piston moves forward and backward only by the hydraulic pressure, but the position of the piston is not constant before and after the forward and backward movement of the piston when the piston moves forward and backward using the actuator. Specifically, this is designed so that the seal member has a certain elastic deformation force so that the piston returns to its original position after the hydraulic braking is released based on when the hydraulic braking is released. When moving the piston forward and backward using the actuator, a phenomenon may occur in which the piston does not return to its original position when the piston moves backward using the actuator by the predetermined elastic deformation force of the seal member designed for the hydraulic braking.

To prevent this, when the piston 100 moves backward using the actuator 300, the hydraulic brake pressure in the hydraulic chamber 33 of the cylinder 31 may increase and the pressure in the seal member accommodation space 503 of the seal groove 501 may increase, so the pressure applied to the seal member 502 increases, thereby preventing the piston 100 from moving backward further than the initial position. Specifically, the pressure in the seal member accommodation space 503 of the seal groove 501 may increase, so that the pressure application direction of the seal member 502 may be deformed. The seal member 502 may be deformed in the direction opposite to the retraction direction of the piston 100, thereby preventing the piston 100 from moving backward further than the initial position. Through this, the problem that the position of the piston before and after the forward and backward movement of the piston 100 is not constant and the errors occur may be prevented.

The caliper brake according to another exemplary embodiment of the present disclosure is not limited to what is illustrated in the drawings. The piston 100 may include a first piston and a second piston. The cylinder 31 and the first piston include a first seal groove and a second seal groove that are recessed in the inner surface thereof. The cylinder 31 and the first piston may include a first seal member that is accommodated in the first seal groove and interposed between the first piston and the cylinder 31, and a second seal member that is accommodated in the second seal groove and interposed between the first piston and the cylinder 31. The first piston may further include a guide groove that is formed to penetrate axially to accommodate at least a portion of the second piston, and the second piston may be slidably disposed in the guide groove. The above components are the same as the components, shapes, arrangements, and operating structures according to the above-described exemplary embodiment of the present disclosure. In addition, the operating structure and method of the hydraulic supply unit 400 described above may also operate in the same manner even in the case of the first seal groove recessed in the inner surface of the cylinder 31 and the first seal member interposed between the first piston and the cylinder 31.

Hereinabove, specific exemplary embodiments have been illustrated and described. However, the present disclosure is not limited to only the above-described exemplary embodiments, but may be variously modified by those skilled in the art to which the present disclosure pertains without departing from the scope and spirit of the present disclosure stated in the claims.

1. A caliper brake, comprising:
a carrier on which a pair of pad plates are installed to be movable toward or away from a disc;
a caliper housing that is slidably installed in the carrier and is provided with a cylinder;
a first piston that is installed in the cylinder and provided to be movable toward or away from the pad plates by hydraulic brake pressure;
a second piston that is installed in the first piston and provided to be movable toward or away from the pad plates by the hydraulic brake pressure; and
a power conversion unit that is installed to penetrate through the cylinder and receives driving force from an actuator to move the second piston forward and backward.

2. The caliper brake of claim 1, wherein the first piston further includes a second seal groove that is recessed in an inner surface, and
a second seal member that is accommodated in the second seal groove and interposed between the first piston and the second piston.

3. The caliper brake of claim 2, wherein the second seal member includes:
a first bent part that is accommodated in the second seal groove; and
a second bent part that is bent and extends toward the second piston from the first bent part and at least partially contacts the second piston.

4. The caliper brake of claim 2, wherein the cylinder further includes a first seal groove that is recessed in an inner surface, and
a first seal member that is accommodated in the first seal groove and interposed between the first piston and the cylinder.

5. The caliper brake of claim 1, wherein the first piston includes a guide groove that is formed to penetrate axially and accommodates at least a portion of the second piston.

6. The caliper brake of claim 5, wherein the second piston is slidably disposed in the guide groove.

7. The caliper brake of claim 5, wherein the second piston is provided to be movable forward and backward integrally with or independently from the first piston.

8. The caliper brake of claim 3, wherein when the first piston and the second piston move forward and backward by the hydraulic brake pressure, the first bent part and the second bent part move forward and backward integrally, and
when the power conversion unit moves the second piston forward and backward, at least a portion of the second bent part is in close contact with the second piston and elastically deformed.

9. The caliper brake of claim 1, wherein the power conversion unit includes:
a spindle member that is installed to penetrate through a rear portion of the cylinder and rotates by receiving rotational force of an actuator; and
a nut member that moves forward and backward according to a rotation of the spindle member and pressurizes and depressurizes the second piston.

10. The caliper brake of claim 1, wherein the first piston and the second piston further include a first contact part and a second contact part that are in contact with the pad plate, and
in a driving state or when a parking brake is released, the first contact part and the second contact part are disposed on the same reference line.

11. The caliper brake of claim 9, wherein the nut member is interposed between the spindle member and the second piston.

12. A caliper brake, comprising:
a carrier on which a pair of pad plates are installed to be movable toward or away from a disc;
a caliper housing that is slidably installed in the carrier and is provided with a cylinder;
a piston that is installed in the cylinder and provided to be movable toward or away from the pad plates by hydraulic brake pressure;
a power conversion unit that is installed to penetrate through the cylinder and receives driving force from an actuator to move the piston forward and backward; and
a hydraulic supply unit that is provided with the cylinder and a passage so that a fluid inside the cylinder flows in and out, generates the hydraulic brake pressure inside a hydraulic chamber of the cylinder during a parking brake, and releases the hydraulic brake pressure inside the hydraulic chamber when the parking brake is released,
wherein the hydraulic supply unit blocks a transmission of hydraulic pressure through the passage so that additional hydraulic brake pressure is generated inside the hydraulic chamber for a preset time when the parking brake is released.

13. The caliper brake of claim 12, wherein the hydraulic supply unit blocks the transmission of the hydraulic pressure through the passage so that the additional hydraulic brake pressure is generated for the preset time when a pressurized state of the piston by the power conversion unit is released during the releasing of the parking brake.

14. The caliper brake of claim 12, wherein the caliper housing includes an oil port that is connected to the hydraulic supply unit and has a fluid flow in and out therethrough.

15. The caliper brake of claim 12, wherein the cylinder includes:
a seal groove that is recessed in an inner surface; and
a seal member that is accommodated in the seal groove and interposed between the cylinder and the piston.

16. The caliper brake of claim 15, wherein when the parking brake is released, the transmission of the hydraulic pressure through the passage is blocked so that the pressure applied to the seal member increases for the preset time.

17. The caliper brake of claim 13, wherein the piston includes:
a first piston that is installed in the cylinder and provided to be movable toward or away from the pad plate by the hydraulic brake pressure;
a second piston that is installed in the first piston and provided to be movable toward or away from the pad plate by the hydraulic brake pressure.

18. The caliper brake of claim 17, wherein the cylinder and the first piston include a first seal groove and a second seal groove that are recessed in an inner surface,
a first seal member that is accommodated in the first seal groove and interposed between the first piston and the cylinder, and
a second seal member that is accommodated in the second seal groove and interposed between the first piston and the cylinder.

19. The caliper brake of claim 18, wherein the first piston further includes a guide groove that is formed to penetrate axially and accommodates at least a portion of the second piston, and
the second piston is slidably disposed in the guide groove.

20. The caliper brake of claim 13, further comprising:
an electronic control unit that controls operations of the actuator and the hydraulic supply unit,
wherein the electronic control unit transmits a signal to the hydraulic supply unit after the preset time has elapsed when the parking brake is released to allow the transmission of the hydraulic pressure through the passage.
